(19) United States
(12) Patent Application Publication
(10) Pub. No.: US 2015/0076959 A1
(43) Pub. Date: Mar. 19, 2015

(54) METHOD OF PRODUCING A ROTOR OF AN ELECTRIC MACHINE AND ROTOR OF AN ELECTRIC MACHINE

(71) Applicants: Peter Ehrhart, Munchen (DE); Jens Steffen, Starnberg (DE); Anton Mueller, Tutzing (DE)

(72) Inventors: Peter Ehrhart, Munchen (DE); Jens Steffen, Starnberg (DE); Anton Mueller, Tutzing (DE)

(73) Assignee: L-3 Communications Magnet-Motor GmbH, Sarnberg (DE)

(21) Appl. No.: 14/361,984

(22) PCT Filed: Dec. 6, 2011
(86) PCT No.: PCT/EP2011/071966

§ 371 Date: Nov. 25, 2014

(51) Int. Cl. H02K 15/03; H02K 1/27

(52) U.S. Cl. CPC H02K 15/03; H02K 1/27
USPC 310/261.1; 29/598; 29/732

(57) ABSTRACT

The invention relates to a method of producing a rotor (10) of an electric machine, the rotor (10) comprising a rotor body (14) adapted to be rotated about a rotor axis (A) as well as at least one rotor component (16) to be mounted to the rotor body (14), said method comprising the steps of: arranging the rotor component (16) on the rotor body (14) and winding a wire-like structure (20) around an outer circumference (12) of the rotor body having the rotor component (16) arranged thereon so as to form a bandage (18), with the wire-like structure (20) during winding thereof being held under an adjustable bias.

### RELATED APPLICATIONS

The present application claims the benefit under 35 U.S.C. §371 of International Patent Application No. PCT/EP2011/071966, having an international filing date of Dec. 6, 2011, the content of which is incorporated herein by reference in its entirety.

### FIELD

The invention relates to a method of producing a rotor of an electric machine and moreover to a rotor produced by such method. The rotor is to be usable primarily with high-speed electric machines, in particular high-power electric machines and/or electric machines with rotors of large construction and concomitantly high requirements as to mechanical strength at high circumferential speeds. The invention also relates to an apparatus for producing such rotor.

### BACKGROUND

A common type of construction of electric machines for fulfilling the requirements mentioned are permanently excited electric machines. For permanently excited electric machines with fast-rotating rotors of large construction, for example with rotor diameters greater than 150 mm and speeds above 2000 rounds per minute (rpm), there are specific measures necessary to secure the magnets on the rotor against the considerable centrifugal forces acting on the magnets. Usual measures are: (1) material-bonding attachment of the magnets on the magnetizable rotor carrier or arm by means of an adhesive, (ii) force-fit fixation of the magnets by a nonmagnetic external bandage, (iii) form-fit mounting by “burying” the magnets in a sheet-metal package and by means of mechanical mounting elements, respectively. Measures (i) to (iii) may also be combined.

All measures involve advantages and disadvantages. Adhesive bonding of the magnets pursuant to (i), in the light of the limited strength of adhesives, involves disadvantages in case of high centrifugal force loads due to high speeds. This effect is particularly pronounced when the rotor at the same time is subject to higher temperatures. Moreover, fatigue is to be expected with adhesives in the course of time, which however is strongly dependent on the environmental conditions in which the rotor is used. The result in the end is substantially uncontrolled lifting off of the magnets when subject to centrifugal forces, and thus a safety risk.

The magnets can be mounted to the rotor by bandages in force-fitting manner, cf. for example DE 10 2009 043 224 A1, EP 1 369 976 B1 or DE 10 2006 015 037 A1. Common bandages are made of nonmagnetic material or fiber-reinforced plastics and are applied to the rotor with a bias. The bias of the bandage is to be in an appropriate ratio to the centrifugal force to be expected, and possibly should be dimensioned slightly larger than the centrifugal force to be expected. This necessitates fitting tolerances between bandage and rotor that have to be observed relatively closely.

The common practice for manufacturing bandages of fiber-reinforced plastics materials consists in winding firstly a bandage on a winding mandrel with some undersize and then pulling the bandage onto the rotor. This can be effected e.g. by brief heating of the bandage and “shrinking” the same onto the rotor. For this purpose, there are frequently used so-called “prepregs” having fiber-reinforcements of fiberglass (GFK), carbon fiber (CFK) or ceramic fiber (KFK) materials in a plastics matrix. It has turned out, however, that bandages of such fiber-reinforced plastics materials do not work reliably at all times since it is difficult to pull such bandages onto the rotor with a bias and since they are easily damaged due to their anisotropy and brittleness. The lacking plastic strain capability of fiber-reinforced plastics materials turns out to be disadvantageous as well.

For producing bandages of metals, an approach has become accepted in which a thin-walled metal tube is made in undersize and is pulled, pressed or shrunk onto the rotor.

With bandages of metal, there is necessarily a closed metal surface in the air gap between rotor and stator in which there are eddy currents flowing, reducing the efficiency of the machine. Also, additional eddy current heating is unavoidable and in many cases—not least due to different thermal expansion of bandage and rotor core with permanent magnets—leads to unacceptable changes of the bias properties. This becomes felt in disturbing manner in particular when, due to high speed and/or large construction of the rotor, there are occurring high centrifugal force loads during operation. For preventing the losses in the bandage from becoming excessively large, the frequencies of the alternating fields must be kept sufficiently low, so that the closed metal bandage is poorly suited for multi-pole and thus high-torque drives.

Metal bandages are manufactured generally from non nonmagnetic metals since, when ferromagnetic or magnetizable metals are used, part of the magnetic flux is directly short-circuited from magnet to magnet and does not flow through the stator.

Bandage concepts necessarily involve an increase in the magnetic gap between rotor and stator. This is inconvenient especially as the effectiveness or efficiency of an electric machine in a non-linear relationship depends on the size of the air gap. Fractions of mm of more or less air gap may already have dramatic effects on efficiency.

Also with form-fitting attachment of the magnets according to variant (iii), a magnetic return path in magnetic portions above and between the magnets typically cannot be avoided, which thus results in corresponding power and efficiency degradation. In so far as form-fitting mounting concepts have been developed in which the air gap is not significantly larger than without mounting of the magnets, as described e.g. in DE 10 2008 055 893 A1, these are relatively complex as regards manufacture and assembly of the rotor.

By combining the afore-mentioned approaches, the disadvantages thereof can be kept within limits, however, at the cost of a relatively complex construction. An example of a construction combining a bandage concept with form-fitting or positive attachment of the magnets, can be found in DE 10 2007 771 B4. In the latter, the magnets are generally held by force-fit on the periphery of the rotor shaft by means of a bandage of a nonmagnetic metal tube. The magnets in addition are supported on the rotor shaft in guide groves in radially movable manner, and the bandage is centrally connected to the rotor shaft by two face-side end caps. These end caps can be expanded elastically in radial direction and thus hold the bandage centered with respect to the rotor axis also in a radially lifted state of the magnets at high speeds.

### SUMMARY

It is the object of the invention to make available a novel method of mounting components of a rotor, in particular of permanent magnets in case of an electric machine excited by permanent magnets, on a rotor body through which the rotor components can be secured against mechanical force effects, in particular those caused by centrifugal forces, in simple and permanently reliable manner. In particular, the assembly expenditure for mounting the components is to be reduced over known solutions. Moreover, the invention is to indicate a correspondingly manufactured rotor.

According to the invention, this object is met by a method of producing a rotor of an electric machine, the rotor comprising a rotor body adapted to be rotated about a motor axis as well as at least one rotor component to be mounted to the rotor body, the method comprising the steps of: arranging the rotor component on the rotor body and winding a wire-like structure around the outer circumference of the rotor body having the rotor component arranged thereon so as to form a bandage, with the wire-like structure during winding thereof being held under an adjustable bias. The bandage obtained in this way may also be referred to as a “wire-wrap bandage”. For example, the rotor body may be in connection to a motor shaft.

The utilization of a wire-like structure, i.e. an elongate and flexible structure, which is generally thin (i.e. has a very small cross-sectional area in relation to its length), for winding around the rotor permits the use of material for the wire-wrap bandage that is of comparatively high strength due to the manufacturing process used for wires. Particularly high solidification or hardening is achieved with drawn wires, due to the manufacturing process of the same, in particular cold-drawn wires. Such wires as a rule are made from metal materials. For the bandages according to the invention, for example wire-like structures drawn from titanium, titanium alloys or certain stainless steels have proven suitable. Such materials can be used for making wire-like structures of high tensile strength. Such wire-like structure permits high biasing forces to be obtained already with low bandage thickness, and thus are excellently suited to fix rotor components that are subject to high centrifugal forces. In addition thereto, it has turned out that a number of such wire-like structures, also after hardening thereof occurring during forming into the wire-like structure, still have a sufficient plastic strain capability so that they will not break immediately upon reaching the tensile strength, but rather react to local excessive loads by elongation while retaining the tensile force. This holds, for example, for a number of metals and metal alloys, including the afore-mentioned metal materials titanium and alloys thereof as well as some stainless steels. Such wire-like structures thus do not only display high strength, but are also “good-natured”, i.e. they can be wound reliably and with defined bias.

The higher the bias adjusted in winding the bandage according to the invention, the higher the centrifugal forces that the bandage may be subject to, for a given material cross-sectional area. With the afore-mentioned materials, it is easily possible to choose a bias in a range just slightly below the yield strength of the wire-like structure. Often it will even be possible to work immediately at the yield strength of the wire-like structure or to slightly overstretch the wire-like structure. In some cases it will even be possible—as there is a certain distance in terms of strain between the tensile strength and the yield strength—to wind the wire-like structure with a bias that is above the yield strength of the same and that may possibly come close to the tensile strength of the same. It is advantageous in this regard when substantially non-brittle wire-like structures are used with which, in a tensile test, the tensile strength is as remote as possible from the yield strength in terms of strain. It is favorable when the strain, upon reaching of the tensile strength, is far above the strain upon reaching of the yield strength, as this permits high plastic strain. This property distinguishes the wire-like structures according to the invention over high-strength, but brittle materials, such as glass fiber or ceramic fiber reinforced materials in which yield strength and tensile strength are very close to each other in terms of strain.

The term “yield strength” in essence is to be understood as the stress at which, in a tensile test with a wire-like structure, an appreciable plastic or permanent deformation occurs, e.g. as indicated in a stress/strain diagram. For most wire-like structures, the strain limit, as a rule the 0.2% offset strain limit Rp₀₂, can be used. With wire-like structures displaying a pronounced yield strength Re, the yield strength Re may also be used as reference point as of which the structure starts to undergo appreciable plastic deformation.

The tensile strength Rm of a wire-like structure is the stress determined from the maximum tensile force a tensile test, e.g. as indicated in a stress/strain diagram, in relation to the original cross-sectional area of the sample. In a stress/strain diagram, the tensile strength Rm results from the maximum stress occurring prior to fracture of the wire-like structure.

For producing a bandage of wire-like structure (wire-wrap bandage), the winding process on a rotor can be performed quite simply. There are just required a lathe for the rotor and an arrangement for adjusting and optionally controlling the bias or tensile force on the wire-like structure. The bandage may also be wound and attached relatively easily on rotors having complicated geometry of the outer surface, e.g. in the form of polygons. By utilizing wire-like structures of reduced cross-sectional area only, it is possible to keep within tolerable limits magnetic losses and losses due to eddy currents occurring in use. The selection of suitable materials for the wire-like structure may be contributory to this effect as well.

In the method, the wire-like structure may be unwound e.g. from a supply roll and passed through a wire guide means onto the outer circumference of the rotor to be provided with a wire-wrap. The rotor body resting on a support may be caused to rotate about its rotor axis, with the bias of the wire-like structure in the section between the wire guide means and the rotor body being adjusted by cooperation of the wire guide means and a torque control acting on the rotor body.

The wire guide means may act e.g. as a bias supporting means which sets a corresponding resistance force corresponding to the desired bias against the transport of the wire-like structure. This resistance force is overcome by a torque produced by a corresponding rotational force acting on the rotor. In doing so, the desired bias in the wire-like structure is produced.

The bias of the wire-like structure can be actively controlled during winding, typically by a feedback control.

When the wire guide means is used, the active control of the bias of the wire-like structure may be effected with the aid of the wire guide means. The latter may be provided e.g. in the form of a bias setting means for supporting the bias force. The current bias of the wire-like structure between the bias setting means and the outer circumference of the rotor is measured, and in accordance therewith the supporting force of the wire guide means to be overcome for conveying the wire-like structure through the wire guide means is increased or decreased accordingly. As an alternative, it is also possible to control the torque of the drive acting on the rotor body in accordance with the prevailing bias and the nominal bias of the wire-like structure in the section between wire guide means and rotor body. In certain cases, it may also be advantageous to actively control, typically by a feedback control, both the supporting force of the wire supply means and the torque of the drive acting on the rotor body.

In a preferred development, the maximum bias of the wire-like structure may be adjusted between 50 and 100% of the tensile strength of the wire-like structure, preferably between 70 and 100% of the tensile strength of the wire-like structure, and in particularly preferred manner between 80 and 100% of the tensile strength of the wire-like structure. The closer the bias is set to the tensile strength of the wire-like structure during the winding operation, the higher the centrifugal forces the bandage may be subjected to for given cross-sectional area of the bandage.

The bias may vary in the course of the winding operation, e.g. a lower bias may be set at the beginning and at the end of the winding operation, typically by a feedback control.

The maximum bias can be selected as a function of the following parameters: (i) rotor speed and/or (ii) mass of the rotating rotor components to be mounted (centrifugal force) and/or (iii) thermal conditions of use and/or (iv) mechanical load conditions (e.g. shocks).

The maximum bias of the wire-like structure may be set to values up to 700 MPa, preferably up to 1300 MPa and in particularly preferred manner up to 2000 MPa.

In preferred embodiments, the maximum bias of the wire-like structure can be set to values of at least 100 MPa, preferably at least 500 MPa and in particularly preferred manner at least 1000 MPa.

In particular, the bias of the wire-like structure at the beginning of the winding operation within a predetermined winding length on the outer circumference of the rotor can be increased from zero or an initial value that is at most 30%, preferably at most 20% and in particularly preferred manner at most 10% of the maximum bias, to a maximum winding bias. In addition thereto or as an alternative, the bias of the wire-like structure at the end of the winding operation within a predetermined winding length on the outer circumference of the rotor can be reduced from a maximum winding bias to zero or a final value which is at most 30%, preferably at most 20% and in particularly preferred manner at most 10% of the maximum bias. For example, the bias of the wire-like structure can be varied at the beginning and/or end of the winding operation within at least one rotor circumferential length to be wound, preferably within at least two rotor circumferential lengths to be wound and still more preferably within at least three rotor circumferential lengths to be wound, between the maximum bias and zero or the initial/final value.

At the beginning of the winding operation, a beginning—and/or towards the end of the winding operation, an end—of the wire-like structure can be fixed in axial direction laterally of the bandage wrap on the outer circumference of the rotor. To this end, e.g. corresponding screws and/or bolts may be used. For this purpose, the rotor may have axially beside the bandage wrap one projecting portion each. These portions may extend beyond the rotor component to be mounted on the rotor.

Winding of the wire-like structure on the outer circumference of the rotor preferably takes place at an angle parallel to a plane orthogonal to the rotor axis. However, winding may also be effected at an angle to such plane.

The outer circumference of the rotor also may have several winding layers of the wire-like structure wound on top of one another. The several winding layers arranged on top of one another may be wound at an identical winding angle with respect to a plane orthogonal to the rotor axis, or may be wound at different winding angles with respect to a plane orthogonal to the rotor axis. In addition thereto, it is also conceivable to wind the several winding layers arranged on top of one another from different wire-like materials. All of these measures permit specific settings in operation of the electric machines to be taken account of by way of the wire-wrap bandage. This holds in particular with regard to the thermal stress to be expected, as the thermal expansion of the various winding layers may be designed each for a specific one of a plurality of operating temperatures to be expected, and/or as each winding layer may be made of a material that is optimized with respect to a respective operating temperature to be expected.

Particularly, a wire-like structure with a diameter of at least 0.2 mm, preferably with a diameter of at least 0.3 mm and in particularly preferred manner with a diameter of at least 0.5 mm, may be wound onto the outer circumference of the rotor.

Moreover, a wire-like structure having a diameter of at most 3 mm, preferably a diameter of at most 2.5 mm and in particularly preferred manner a diameter of at most 2 mm, may be wound onto the outer circumference of the rotor.

A modification that turned out particularly favorable is an embodiment in which a wire-like structure having a diameter of about 1 mm is wound onto the outer circumference of the rotor.

The wire-like structure does not need to be of completely round cross-section. Other cross-sections are conceivable as well, in particular oval, quadrangular concave, quadrangular convex. The diameter meant thus is an effective diameter which results from a circle circumscribing the cross-sectional area of the wire-like structure.

Furthermore, it has turned out that winding a bandage of wire-like material on a rotor, as described hereinbefore, leads to safe mounting of rotor components on an outer circumference of the rotor which has a diameter of at least 30 mm, preferably of at least 100 mm and in particularly preferred manner of at least 300 mm. It has turned out in addition that safe mounting of rotor components is possible for diameters of the outer rotor circumference to be wound between about 2000 mm and 2500 mm and as far as up to 3500 mm.

Moreover, it has turned out that mounting in the manner described hereinbefore provides for safe attachment of rotor components up to maximum speeds of at least 4000 rpm and maximum centrifugal accelerations of 36000 m/s², respectively. It has been established in preferred embodiments that safe conditions can be achieved even with maximum speeds of up to 5000 rpm and maximum centrifugal accelerations of up 56000 m/s², respectively, and in particularly expedient embodiments even with maximum speeds of up to 6000 rpm and maximum centrifugal accelerations of up to 81000 m/s², respectively.

Opposite the rotor, usually via an air gap, there is disposed a stator carrying electric windings. The rotor has poles formed of permanent magnets that are located opposite corresponding magnet poles on the stator.

The wire-like structure can be wound across an axial length of at least 25 mm on the outer circumference of the rotor, preferably across an axial length between 25 mm and 1000 mm, and in particularly preferred manner across an axial length between 50 mm and 1000 mm.

The rotor component to be mounted primarily comprises permanent magnets of a permanently excited rotor. The rotor component preferably is attached to an outer surface of the rotor body. For example, permanent magnets of a rotor often are in the form surface magnets. These may either be arranged just at the surface and then may be held solely with the aid of the wire-wrap bandage, or may be held on the rotor body in addition by material bonding, force-fit and/or form-fit.

The wire-like structure can be wound onto a plurality of rotor components distributed around the outer circumference of the rotor, with the outsides of the rotor components, in a cross-section orthogonal to the rotor axis, being arranged on a polygonal course, and with the wire-like structure being wound around the polygonal course. Applying a wire-wrap bandage in the manner described is particularly expedient with an arrangement of rotor components, e.g. permanent magnets, along the outside of the rotor so that the outsides of the rotor components constitute the supporting or abutment surface for the bandage. To this end, the outsides of the rotor components need not be ground first to a suitable outer diameter of the rotor, as it is generally necessary for applying a pre-fabricated bandage. Instead, the wire-like structure can be wound directly onto a polygonal outer contour, even if there are two circumferentially successive rotor components directly abutting each other.

The rotor component to be mounted, at least with respect to forces acting in circumferential direction, may also be attached in form-fit manner in recesses formed in the rotor body. The rotor component to be secured by way of the wire-wrap bandage against centrifugal forces acting in radial direction can be designed e.g. in the form of “buried” magnets. Such magnets are arranged in pockets formed in the rotor body. Securing against forces acting in circumferential direction then is implemented substantially in form-fit manner by the rotor body. Securing against centrifugal forces acting in radial direction can be obtained completely or partially by the wire-wrap bandage.

In certain embodiments, there may be provided portions axially beside, i.e. to the left and the right, of the rotor component in which deflection of the winding angle of the wire wrap takes place.

However, in addition to the permanent magnets of a rotor excited by permanent magnets, there may be provided still other permanent magnet configurations in the rotor, such as e.g. flux-concentrating trapezoidal geometries. Also such permanent magnet configurations, be they disposed at the surface of the rotor body or embedded in the rotor body completely or partially, can be held by the wire-wrap bandage. In these configurations, too, the centrifugal forces act against the adhesive strength or apply loads to (generally ferromagnetic) supporting webs which then are supported by the wire-wrap bandage of wire material.

The wire-wrap bandage, however, may also serve to secure other rotor components than permanent magnets against centrifugal forces acting in radial direction. Similar to a rotor equipped on the outside thereof with surface magnets (inner rotor), other rotors equipped with rotor components that are subject to centrifugal forces during operation can be provided with the wire-wrap bandage as well. Such rotor components may be e.g. high-speed inductive contactors in which metal pieces of special materials are embedded in a rotor carrier.

It is even conceivable to wind a wire-like structure onto a rotor that is not provided with permanent magnets.

Particularly, the wire-like structure for producing the bandage may be made from metal material. The term metal in this context is to be understood to comprise pure metals and particularly metal alloys. Metals generally have good mechanical behavior. In particular, they often have sufficiently high tensile strength for producing the necessary bias, along with good plastic deformability.

The wire-like structure preferably has a tensile strength of at least 700 MPa and more preferably of at least 1300 MPa, with at least 2000 MPa being particularly preferred.

The wire-like structure preferably has a modulus of elasticity (Young's modulus) of at the most 250 GPa and more preferably of at the most 180 GPa, with at the most 130 GPa being particularly preferred. The Young's modulus should be selected to achieve bias and elasticity as high as possible. This can be achieved particularly well when the Young's modulus is not excessively high, especially when the Young's modulus is within the ranges indicated. A relatively low Young's modulus also provides the advantage that thermal strain differences between rotor and bandage are translated to slight stress differences only and that strain defects have less critical effects.

The wire-like structure preferably has a plastic deformability of at least 1% and more preferably of at least 3%, with 5% being particularly preferred. The plastic deformability indicates the relative strain between offset strain limit Rp_{0.2} or yield strength, respectively, and tensile strength Rm in the stress-strain diagram in %.

The use of a wire-like structure made of metal permits low thermal stresses between rotor and bandage, as the metal of the wire-like structure and the metal of the rotor core may be selected such that both show similar thermal expansion.

In embodiments, the wire-like structure may have an electric conductivity of at the most 10 MA/(V·m), preferably at the most 5 MA/(V·m), with at the most 3 MA/(V·m) being particularly preferred. This design possibility has the aim of preventing possibly arising eddy currents within the wire-wrap bandage due to the magnetic alternating fields introduced during operation of the machine. To this end, it is possible in addition or as an alternative to provide the wire-like structure with an insulating varnish coating or an insulating spun sheathing. The insulating varnish coating or spun sheathing can be applied to the wire-like structure prior to winding of the same, e.g. by pulling the wire-like structure through a corresponding varnish bath. As an alternative, an insulating varnish coating or wound sheathing can also be applied after the winding operation. This is preferably effected layer for layer.

This measure is preferably employed with machines having a large number of poles, e.g. machines with more than 4 poles and/or with machines using high rotational frequency, e.g. a rotational frequency of 2000 rpm or more. With such machines, eddy current losses, which are proportional to the square of the wire diameter and to the square of the frequency, make themselves felt in extremely negative manner.

In producing a multi-layer wire-wrap bandage, there may be applied a layer of insulating material between individual layers of the wire-like material wound onto the circumference of the rotor.

In accordance with embodiments, the wire-like structure can be made from nonmagnetic material. In this context, any material not having ferromagnetic properties may be deemed to be nonmagnetic. Nonmagnetic materials principally have a magnetic conductivity or magnetic permeability that is independent of the strength of external magnetic fields, in particular those which the bandage in the electric machine is subjected to during operation. In case of suitable nonmagnetic materials, the value of the magnetic permeability often is in the order of one. Nonmagnetic materials are chosen in order to possibly suppress an influence on the magnetic flux between rotor and stator of the electric machine in the air gap due to magnetic short-circuiting via the bandage.

The wire-like structure, for example, can be made of titanium or a nonmagnetic stainless steel. The term “titanium” in this context is to comprise pure titanium as well as titanium alloys. The term “stainless steel” is to be understood in general, as collective term for high-alloy, low-alloy or unalloyed steels of specific purity, e.g. steels whose contents of steel accompanying elements, such as sulfur and/or phosphorus, do not exceed a certain limit. More details for distinguishing stainless steels from basic steels and quality steels can be found in DIN EN 10 020 (2000).

Both materials offer a good compromise with respect to the properties demanded. Titanium is nonmagnetic and, in comparison with other metals, has a quite low modulus of elasticity (Young's modulus) of approx. 105 GPa with a plastic strain capacity between 5 and 10%. With wires drawn from titanium, a bias suitable for many applications and ranging between 1000 and 1300 MPa can be obtained. At the same time, titanium is nonmagnetic to such an extent that the magnetic situation in the air gap, apart from an increase of the magnetically effective air gap, is affected only insignificantly. The electric conductivity of titanium is rather low, so that eddy currents do not make themselves felt excessively. Another contributory fact in this regard is that the thermal expansion of titanium is very similar to that of rotor cores commonly used. Heating of bandage and rotor core caused by eddy currents thus does not result in an alteration of the bias. This facilitates also dimensioning.

The same holds for a number of nonmagnetic or non-magnetizable stainless steels. Examples are stainless steels with material numbers 1.4301 (tensile strength≈1770 MPa), 1.4401 (tensile strength≈1500 MPa), 1.4541, Phynox-Elgiloy CoCr20Ni16Mo7 (tensile strength up to 2000 MPa).

As an alternative, the wire-like structure can be made from a ferromagnetic material. In this context, a ferromagnetic material is understood to be a material that can be magnetized by an external magnetic field such that the magnetic field in the interior of the material is strengthened disproportionately to the strength of the magnetic field applied. Ferromagnetic materials have a value of magnetic permeability that is dependent on the strength of an external magnetic field. As long as magnetic saturation of the ferromagnetic material is not yet reached, the magnetic permeability of ferromagnetic materials is much higher than one. This condition is striven for in operation.

The winding is applied to the rotor magnets in the air gap between rotor and stator. As the actually present air gap for safety reasons must have a certain minimum size of typically 1 to 3 mm, attaching the wire-wrap bandage results in an extension of the magnetically effective air gap and thus results in a reduction of efficiency of the electric machine. This reduction is drastic as the efficiency of an electric machine is disproportionately dependent on the size of the air gap. When a wire-like structure of ferromagnetic type itself is used for forming the wire-wrap bandage, the wire-wrap bandage virtually extends the rotor. Thus, the result upon application of the bandage is merely a slightly larger external radius of the rotor, however no increase in the magnetically effective air gap.

In case the entire wire-wrap bandage is ferromagnetic, undesired magnetic short-circuiting results between adjacent poles. For avoiding such magnetic short-circuiting, it may be advantageous to bridge the space between individual poles of the machine (e.g. the space between the permanent magnets on the rotor in case of a machine excited by permanent magnets) using non-magnetizable or more poorly magnetizable wire-wrap bandage material. This can be achieved by employing a ferromagnetic material having successive first and second portions, with the first portions being easier to magnetize and the second portions being harder to magnetize. The arrangement of easier and harder magnetizable portions may be performed in advance, and in doing so care has to be taken that the distances between the first portions and the length of the second portions, respectively, corresponds to the distance between successive poles of the machine that varies with increasing radius of the rotor body. The ferromagnetic material in particular may be a soft-magnetic basic material that is subjected to a treatment in which influence is taken on the magnetic permeability and/or magnetic remanence and/or coercitive field strength of the material in the first portions and the second portions, respectively, by way of suitable measures. The permeability can be changed, for example, in certain portions by mechanical treatment, such as hardening, and/or thermal treatment, such as annealing. In similar way, the magnetic remanence and coercitive field strength can be influenced.

For example, in portions of the wire-like structure disposed between the rotor poles in the wound state, a high magnetic reluctance (i.e. lower magnetic permeability) can be introduced. This greatly reduces the afore-mentioned magnetic short-circuiting between the rotor poles.

For the wire-like structure, there may be used an anisotropic ferromagnetic material that is magnetizable such that the preferred direction of the vector of the magnetization after winding points in the radial direction of the rotor. The advantage of this material characteristic resides in that the preferred direction of the magnetizability of the wire material is parallel to the magnetizing direction of the rotor permanent magnets.

Disorder and thickness increases due to path changes can largely be avoided when the wire-like structure is composed of individual wires wound in parallel.

By means of the manufacturing steps described hereinbefore, it is possible to produce a rotor for an electric machine. The electric machine comprises a rotor body adapted to be rotated around a rotor axis being connected to a motor shaft, and has at least one rotor component to be mounted on the rotor body and which has a wire-wrap bandage of a wire-like structure that is wound around an outer circumference of the rotor body having the rotor component disposed thereon, so as to form a bandage. The wire-like structure is held on the rotor body under an adjustable bias, with the average bias of the wire-wrap bandage thus formed being greater to withstand the largest centrifugal forces to be expected during operation. Such a rotor may have one or more of the properties described hereinbefore. In addition to the manufacturing method described, such a rotor is deemed to constitute patentable subject matter of its own.

The invention moreover relates to an apparatus for producing a rotor for an electric machine. The rotor comprises: a rotor body adapted to be rotated around a rotor axis, e.g. by being connected to a motor shaft, at least one rotor component to be mounted on the rotor body as well as a wire-wrap bandage of a wire-like structure that is wound around an outer circumference of the rotor body having the rotor component disposed thereon so as to form a bandage. The apparatus comprises: a wire guide means for guiding the wire-like structure onto the outer diameter of the rotor to be provided with a wire wrap, and a support for the rotor body which permits the rotor body resting thereon to be set into rotation. Furthermore, the apparatus permits adjustment of the bias of the wire-like structure by cooperation of the wire guide means and a torque control acting on the rotor body. The apparatus may comprise a control for actively controlling the bias of the wire-like structure in the section thereof between the wire guide means and the rotor body by cooperation of the wire guide means and the torque control acting on the rotor body.

### BRIEF DESCRIPTION OF THE DRAWINGS

The invention will be described in more detail hereinafter by way of embodiments with reference to the drawings wherein:

FIG. 1 shows a simplified schematic illustration of an apparatus for making a rotor with wire-wrap bandage according to an embodiment;

FIG. 2 shows a simplified schematic sectional view along the rotor axis, illustrating half of a rotor provided with a multi-layer wire-wrap bandage according to an embodiment;

FIG. 3 shows a simplified schematic illustration of a rotor provided with a wire-wrap bandage according to an embodiment; and

FIG. 4 shows a simplified schematic sectional view along the rotor axis, illustrating a rotor with a multi-layer wire-wrap bandage according to an embodiment.

### DETAILED DESCRIPTION OF THE PREFERRED EMBODIMENTS

The figures illustrate embodiments of the rotor provided with a wire-wrap bandage and of the apparatus for producing the rotor. The figures equally use the same reference numerals for designating like or similar components. However, such components are described in more detail referring to one of the figures only, while it is to be understood that such description is also applicable to the component(s) bearing the same reference numeral in the other figures, unless express reference is made to specific differences.

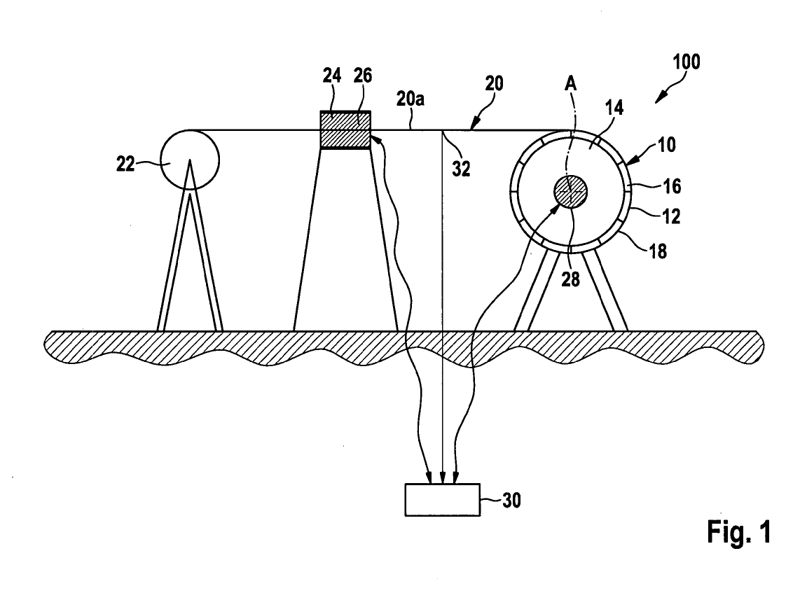

FIG. 1 shows in a highly simplified schematic view an apparatus 100 for producing a rotor 10 having an outer circumference 12 and a rotor body 14, according to an embodiment. Rotor 10 has an axis of rotation A and is designed in essence to be rotationally symmetric with respect to this axis of rotation A.

Rotor 10 serves for use with an electric machine, not shown in the drawings, which has a stator and a rotor that are coaxially arranged around a common axis A. Between rotor 10 and stator (not shown), there is provided an air gap (in FIG. 1 adjacent the outer circumference of rotor 10).

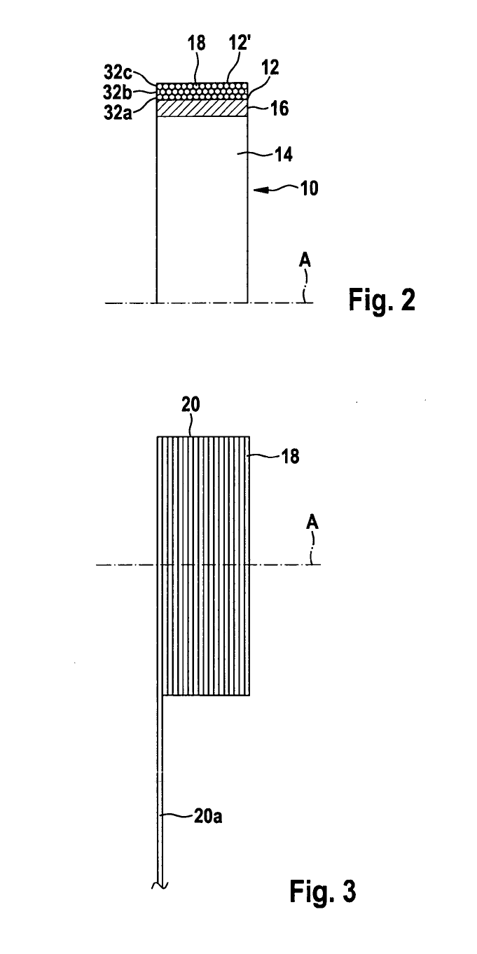

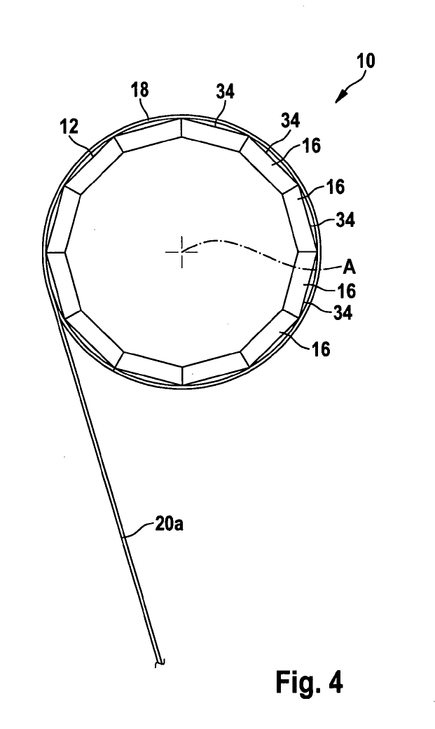

The stator generally carries electric windings that are arranged around winding cores and facing the rotor via the air gap. The electric machine preferably is an electric machine excited by permanent magnets in which the rotor 10 is provided with permanent magnets 16 (shown schematically in FIG. 1, cf. also FIG. 2 or FIG. 4) which are disposed around the outer circumference 12 (internal rotor) or an inner circumference (external rotor) of rotor 10, respectively, so as to face the stator windings formed on the stator via the air gap. In the construction illustrated in FIG. 1, rotor 10 is designed as internal rotor in which the permanent magnets 16 are disposed near an outer circumference 12 of rotor 10. The permanent magnets 16 may be mounted on the rotor surface as surface magnets and/or may be received completely or partially inside pockets formed in rotor body 14, in the manner of so-called “buried” magnets.

Rotor 10 consists of several separate parts. These include magnetically active parts, such as the permanent magnets 16, but also a magnetic return path via which the magnetic flux within rotor 10 takes place between the permanent magnets 16. The magnetic return path is not shown in more detail in the figures. It may have the configuration of a hollow cylindrical element and serve at the same time as a structural part, i.e. as supporting member, for the permanent magnets 16. As an alternative or in addition, there may be provided further structural elements, e.g. inductive contactors in which metal pieces of specific materials are embedded in a rotor carrier or arm, or other permanent magnet configurations provided in rotor 10, e.g. trapezoidal geometries that concentrate magnetic flux.

The permanent magnets 16 preferably are radially magnetized, i.e. the vector of magnetization of the same has a preferred direction pointing in radial direction either away from axis A outwardly or toward axis A inwardly.

The permanent magnets 16, but also other components, as described, are subjected to high centrifugal forces during operation of the electric machine and thus have to be attached to the rotor body 14 or other structural parts in correspondingly firm and reliable manner. This can be effected by way of one or more of the constructions described at the outset, i.e. by material bonding using adhesive, by force-fit using a bandage and/or by form-fit by embedding in pockets formed in rotor body 14 or by structural parts cooperating with rotor body 14, respectively. In case a bandage is used for attachment, it is provided according to the invention to use a wire-wrap bandage 18 according to embodiments still described in more detail hereinafter. The wire-wrap bandage 18 is illustrated in FIG. 1 merely by its reference numeral 18. It is shown in more detail in various embodiments in FIGS. 2 to 4. If reference is made to numeral 18 hereinafter, this is to be understood to the effect that the respective statements hold for all embodiments of the bandage, unless expressly stated otherwise.

Bandage 18 is applied to the outer circumference 12 of rotor 10 with a bias and thus holds the individual parts of the rotor 10 together. In addition thereto, the individual parts of the rotor 10 may be joined to each other by means of other connections, e.g. mechanical form-fit connections, adhesive connections etc.

Bandage 18, in the installed state of rotor 10, is located in the air gap between rotor 10 and stator. The bandage 18, at least when it is made from nonmagnetic material, thus increases the distance between the mutually facing, magnetically active parts of rotor 10 and stator since, for safety reasons, the remaining air gap, i.e. the distance between the mutually opposite movable parts of rotor and stator, cannot be reduced below a minimum measure which, depending on the particular design of the electric machine, is between 1 mm and 3 mm. It is to be understood that attempts are made to form the bandage 18 as thin as possible. However, there are limits in this regard as well, since the bandage 18 can secure the rotor components (e.g. permanent magnets 16) to be secured against centrifugal forces only against such centrifugal forces that do not significantly exceed the bias of the bandage multiplied by the cross-sectional area of the same. The thicker the bandage 18, the higher the tolerable centrifugal forces with identical bias of the bandage. In practical application, the thickness of the bandage is relatively low and is in the range of just a few mm or even fractions of mm. For example, a rotor having a diameter of 40 cm, magnets with a thickness of 12 mm and a nominal speed of 3800 rpm, may have a bandage thickness of 0.9 mm. This bandage can be wound as a single layer from 0.9 mm thick wire or in two layers from 0.5 mm thick wire or in three layers from 0.35 mm thick wire. The wire in particular can be made from titanium or a titanium alloy. A wire e.g. of titanium Ti-6Al-4V ELI or a comparable titanium alloy has turned out suitable in this regard. In the illustrations of FIGS. 1 to 4, the bandage 18 is shown with a disproportionately large thickness.

In the method depicted in FIG. 1, a wire-like structure 20 (in the following also referred to as winding wire) is unwound from a supply roll 22 rotatably supported by a supporting block and is guided by a rope or wire guide 24 onto the rotor 10 to be provided with a bandage. The rope or wire guide 24, indicated in FIG. 1 only schematically, comprises a guide means 26 for engagement with the wire-like structure 20 such that the wire-like structure 20 is held in guide means 26 with a holding force corresponding to the desired bias of the wire-like structure 20 being wound onto rotor 10. If the wire-like structure is to be transported through guide means 26, a transportation force directed counter to this holding force has to be applied. During transport through the guide means, due to the retaining or holding force a bias proportional to the holding force is created in the wire-like structure 20 in its section between guide means 26 and rotor 10. The guide means 26 thus at the same time has the function of a bias actuator that sets a bias force resulting in bias of the wire-like structure 20 in its section 20a between guide means 26 and rotor 10.

The rotor 10 to be wound, i.e. to be provided with the wire-wrap bandage, rests on a support 28 coupled to a drive motor (not shown). The support 28 is formed e.g. in a supporting block. The drive motor is operated in torque-controlled manner. Both the drive motor and the guide means 26 are connected to a control means 30. This control means 30 takes over the bias control in such a manner that the control means 30 drives the drive motor for the rotor 10 as well as the guide means 26 so as to determine a specific biasing force and a predetermined torque of the drive motor. The control means 30 preferably performs control such that the actual bias in section 20a of the wire-like structure is detected by a sensor 32 and a corresponding signal is fed to control means 30. By way of a comparison between desired or nominal bias of the wire-like structure 20 and the actual bias detected by the sensor 32 in section 22a, the control means 30 controls the guide means 26 and/or the drive motor of rotor 10 such that the actual bias tracks the desired bias as exactly as possible.

The amount of the predetermined and possibly actively track-controlled bias of the wire-like structure 20 and possibly the accuracy of the tracking control may be determined on the basis of various parameters resulting from the subsequent operation and conditions of use of the rotor 10. Especially the following parameters are feasible: (1) rotor speed and/or (2) mass and arrangement of the rotating rotor components to be secured against centrifugal forces (e.g. permanent magnets 16) and/or (3) subsequent thermal conditions of use and/or (4) subsequent mechanical load conditions (e.g. shocks) of the electric machine. In addition thereto, it has to be considered that the material and the geometry (in particular the cross-sectional area) of the wire-like structure 20 used to form the wire-wrap bandage 18 has an influence on the maximum settable bias. It has turned out in some embodiments that it is favorable to adjust the maximum bias of the wire-like structure 20 in section 20a between 50 and 100% of the tensile strength of the wire-like structure, in other embodiments in particular to values between 70 and 100% of the tensile strength of the wire-like structure 20, and in still other embodiments to values between 80 and 100% of the tensile strength of the wire-like structure 20.

More thorough investigations have revealed furthermore that it is expedient to establish the bias of the wire-like structure 20 in section 20a not in a sudden at the beginning of the winding operation, but rather to increase the bias within one to three revolutions of the rotor 10 from zero or a relatively low initial value to the predetermined maximum bias. In like manner, it has turned out expedient to decrease the bias of the wire-like structure 20 in section 20a at the end of the winding operation slowly from the maximum bias provided to zero or a relatively low final value. For example, the bias both at the beginning of the winding operation and at the end of the winding operation may be established and released, respectively, within one to three revolutions of the rotor 10.

At the beginning of the winding operation, the wire-like structure 20 is mounted at a fixing point provided laterally of the rotor body 14, e.g. a bolt or screw. In like manner, the wire-like structure 20 at the end of the winding operation is mounted at a fixing point provided laterally of the rotor body 14, e.g. a bolt or screw. These fixing points are not illustrated in the drawings.

Eddy currents induced within the wire bandage 18 by the magnetic alternating fields occurring during operation of the electric machine can be suppressed generally in the wire-wrap bandage 18 in that the bandage 18 is composed of a wound, single wire-like structure 20 the cross-sectional area of which does not allow higher electric currents. Moreover, if measures are taken to suppress current flow between possibly mutually abutting sections of the wound wire-like structure 20, e.g. with the aid of a suitable insulation of the wire-like structure 20 by a coating of insulating material, eddy currents are effectively suppressed. It has turned out that, with diameters of the wire-like structure 20 between 0.3 mm and 2 to 3 mm, eddy currents can be kept sufficiently low. The afore-mentioned larger diameters of the wire-like structure 20 between 1 and 3 mm permit effective mounting of rotor components also with respect to centrifugal forces to which such components are subjected to in large and high-speed machines. For example, a rotor having a diameter of 40 cm, magnets with a thickness of 12 mm and a nominal speed of 3800 rpm may have a bandage thickness of 0.9 mm, consisting of one layer of 0.9 mm thick wire, of two layers of about 0.5 mm thick wire or three layers of about 0.35 mm thick wire. The wire may be made in particular from titanium or a titanium alloy. A suitable wire has turned out to be e.g. a wire of titanium Ti-6Al-4V ELI or a comparable titanium alloy. A preferred diameter of the wire-like structure 20 is about 1 mm Speaking of diameter of the wire-like structure 20 in this context, this does not mean that the wire-like structure 20 must have a strictly circular cross-sectional shape. Other cross-sectional shapes are conceivable as well, such as oval or angular cross-sectional shapes. The term diameter in such cross-sectional shapes refers to the effective diameter as measure of the cross-sectional area.

Moreover, it has turned out expedient to make the wire-like structure 20 of a material having an as low as possible electric conductivity. However, at the same time it is also important to use a material with favorable mechanical properties in particular with respect to tensile stress. In particular, care is to be taken to provide for sufficiently high tensile strength and sufficient plastic strain capacity as otherwise the centrifugal forces arising can be taken up by very voluminous bandages only. Some metals have proven particularly advantageous in this respect, e.g. titanium and titanium alloys, respectively, as well as stainless steel. The wire-like structure 20 therefore is made of such metals in currently preferred embodiments. As a matter of principle, a nonmagnetic material should be selected for the wire-like structure 20, in order not to affect the magnetic flux in the air gap. Titanium and its alloys meet this property. Also most of the stainless steels have a sufficiently nonmagnetic behavior in the range of magnetic field strengths of interest here.

A completely different approach consists in making the wire-like structure 20 from a material having ferromagnetic properties. A ferromagnetic material, as compared to a vacuum, has a high magnetic permeability or magnetic conductivity. Examples of ferromagnetic materials are a number of steels, including stainless steels with material numbers 1.4016 and 1.4511 or ferrous metals such as Fe, Ni, Co and alloys thereof. The advantage hereof is that an additional bandage 18 disposed in the air gap between rotor 10 and stator does not result in a significant increase in the magnetic distance between the mutually opposite poles on rotor and stator. Rather, a bandage 18 consisting of ferromagnetic material has the result that the magnetic flux in bandage 18 takes place with less reluctance. This effect can be exploited for passing the magnetic flux between the poles of rotor and stator more effectively and to thus compensate for the increase in the distance between the poles of rotor and stator that is caused by insertion of the bandage 18. In certain embodiments, the bandage 18 may even be designed as an extension of the rotor 10. The magnetically effective distance in the air gap (i.e. the magnetic distance to be bridged by the magnetic flux between rotor and stator) then is as large as or only slightly larger than in a design without bandage 18. The outer circumference of the rotor then may be virtually equated with the outer circumference of the bandage 18, which in FIG. 2 is indicated by numeral 12′.

In order to possibly avoid magnetic short-circuiting, the bandage in the respective intermediate portions between the poles of the machines, if possible, should not be ferromagnetic, or should at least be less ferromagnetic, i.e. should have a magnetic permeability as low as possible and thus high reluctance to magnetic flux. The size of the intermediate portions is determined by the poles of the electric machines, i.e. by the stator windings and optionally by the permanent magnets on the rotor in case of an electric machine excited by permanent magnets. Such a bandage can be obtained e.g. by providing the wire-like structure 20—already prior to winding the same onto rotor—in alternating manner with portions having a ferromagnetic effect (magnetic permeability much higher than one) and portions having an inferior ferromagnetic effect (magnetic permeability in the order of one). The first portions with ferromagnetic properties are arranged mutually spaced apart such that, in winding the same onto rotor 10, they correspond to the distance between the poles of the machines and, in case of a machine excited by permanent magnets, thus come to lie on the permanent magnets 16 of the rotor, while in the intermediate spaces between the poles, e.g. the permanent magnets 16 or the stator winding, the bandage material shows no or an inferior ferromagnetic behavior. To this end, there may be provided a corresponding pretreatment of the wire-like structure 20 in which individual, mutually spaced apart portions of the wire-like structure 20—which is made of corresponding ferromagnetic material—are rendered less ferromagnetic.

Such influencing of the magnetic properties can be implemented by suitable mechanical treatment of the portions concerned. A heat treatment is also feasible as an alternative or in addition. For forming the bandage, it is also possible to use a substantially nonmagnetic wire material which in the desired first portions, i.e. in the region of the rotor poles, has ferromagnetic material applied thereto in addition.

After the pretreatment, the length of the individual first portions of the wire-like structure 20 with ferromagnetic properties should correspond to the circumferential direction of a permanent magnet 16 on the rotor or the extent of the stator windings, respectively, and the length of the second portions between the ferromagnetic first portions should correspond to the extent of an intermediate portion between the permanent magnets 16 in circumferential direction or to the distance between adjacent stator windings, respectively. As an alternative, it is also possible that a wire-like structure 20 of a ferromagnetic material, during winding the same onto rotor 10, is actively transformed to a non-ferromagnetic or at least less ferromagnetic state in the respective portions located between two adjacent permanent magnets 16 on the rotor or stator windings, respectively.

In all of the modifications mentioned it is particularly effective when the wire-like structure 20, in the portions associated with permanent magnets 16 or stator windings, respectively, are magnetized in such a manner that the preferred direction of magnetization points in the radial direction. To this end, the wire-like structure 20 can be made of a corresponding anisotropic ferromagnetic material.

FIG. 2 shows a highly simplified schematic sectional view along the rotor axis A, illustrating half of a rotor 10 provided with a multi-layer wire-wrap bandage 18 according to any embodiment. The multi-layer bandage 18 consists of several layers 32a, 32b, 32c of the wire-like structure 20. Each layer is constituted by a plurality of side-by-side or juxtaposed sections of the wire-like structure 20. The wire-like structure 20 is wound such that the individual juxtaposed sections within a layer extend parallel to each other and that only spaces as small as possible are left between the juxtaposed sections. The winding direction is substantially parallel to a plane orthogonal to rotor axis A. The winding of the individual layers 32a, 32b, 32c with respect to each other is such that the wire sections of all layers extend parallel to each other and the wire sections of one layer each are offset to the adjacent wire sections of the respective layer above and below, respectively. In this manner, a tightest-possible packing of the individual wire sections can be obtained and thus, with a given number of windings of the wire-like structure 20 around rotor 10, the thickness of the bandage 18 in its entirety can be kept as small as possible.

It is also possible to produce a wire-wrap bandage 18 with multi-layer winding of wire-like structure 20 similar to that illustrated in FIG. 2, in which the individual layers 32a, 32b, 32c are wound with slightly different winding angles with respect to a plane orthogonal to rotor axis A, e.g. with two alternating winding angles in the respective successive layers 32a, 32b, 32c. The individual layers 32a, 32b, 32c then are each wound at an angle in mirror symmetry with respect to the plane orthogonal to the rotor axis A. In this manner it is possible to comply with different requirements holding in subsequent operation of the rotor 10. For example, the individual layers 32a, 32b, 32c can be optimized with respect to different thermal conditions which the rotor 10 will be subject to later on. It is also possible to wind the individual layers 32a, 32b, 32c from different wire-like structures 20 (in particular wire-like structures 20 of different materials and/or wire-like structures of different diameters).

FIG. 3 shows a highly simplified illustration of a rotor 10 provided with a wire-wrap bandage 18 according to an embodiment. The drawing reveals the parallel arrangement of the juxtaposed winding sections of the wire-like structure 20 at the outer circumference of rotor 10 having a winding angle substantially parallel to a plane orthogonal to rotor axis A. Moreover, feeding of the wire-like structure 20 to the rotor 10 in the section 20a between rotor 10 and wire guide means 26 can be seen.

Finally, FIG. 4 shows a highly simplified sectional view across the rotor axis A, illustrating a rotor 10 provided with a multi-layer wire-wrap bandage 18 according to an embodiment. The rotor 10 is an internal rotor and has on its outer circumference a plurality of circumferentially successive permanent magnets (only some thereof bearing numeral 16 in exemplary manner). The permanent magnets 16 in general have the shape of parallelepipeds. The surface thereof directed outwardly in the installed position has a substantially planar shape. The magnets 16 thus are not ground to a common outer diameter, but constitute a succession of prism surfaces extending in circumferential direction. This is shown in the sectional view of FIG. 4 as a surrounding polygonal succession of the outsides of the permanent magnets 16. The wire-like structure 20 is wound directly on the prism surfaces 34 and thus forms a wire-wrap bandage 18 of annular outside circumference. Due to the bias of the wire-wrap bandage 18, the permanent magnets 16 are safely held against centrifugal forces occurring during operation. Round grinding of the permanent magnets 16 to establish the outer surface of the rotor 10 is not necessary.

1. A method of producing a rotor (10) of an electric machine, the rotor (10) comprising a rotor body (14) adapted to be rotated about a rotor axis (A) as well as at least one rotor component (16) to be mounted to the rotor body (14), said method comprising the steps of:
arranging the rotor component (16) on the rotor body (14); and
winding a wire-like structure (20) around an outer circumference (12) of the rotor body having the rotor component (16) arranged thereon so as to form a bandage (18), with the wire-like structure (20) during winding thereof being held under an adjustable bias, wherein the wire-like structure (20) is wound with a maximum bias that is above the yield strength and below the tensile strength of the wire like-structure (20).

2. The method of claim 1,
wherein the wire-like structure (20) is unwound from a supply roll (22) and passed through a wire guide means (26) onto the outer circumference (12) of the rotor (10) to be provided with a wire wrap, and the rotor body (14) is caused to rotate about the rotor axis (A), with the bias of the wire-like structure (20) in the section (20a) between the wire guide means (26) and the rotor body (14) being adjusted by cooperation of the wire guide means (26) and a rotational drive acting on the rotor body (14); and
wherein the bias of the wire-like structure (20) is actively controlled during winding.

3. The method of claim 1,
wherein the maximum bias of the wire-like structure (20) is adjusted between 50 and 100% of the tensile strength of the wire-like structure (20), preferably between 70 and 100% of the tensile strength of the wire-like structure (20), and in particularly preferred manner between 80 and 100% of the tensile strength of the wire-like structure (20).

4. The method of claim 1,
wherein the maximum bias of the wire-like structure (20) is set to a value of up to 700 MPa, preferably up to 1300 MPa and in particularly preferred manner up to 2000 MPa, and
wherein the maximum bias of the wire-like structure (20) is set to a value of at least 100 MPa, preferably at least 500 MPa and in particularly preferred manner at least 1000 MPa.

5. The method of claim 1,
wherein the bias of the wire-like structure (20) at the beginning of the winding operation within a predetermined winding length on the outer circumference (12) of the rotor (10) is increased from zero or an initial value to a maximum winding bias, and
wherein the bias of the wire-like structure (20) at the end of the winding operation within a predetermined winding length on the outer circumference (12) of the rotor (10) is reduced from a maximum winding bias to zero or a final value.

6. The method of claim 5,
wherein the bias of the wire-like structure (20) at least at the beginning or at least at the end of the winding operation is varied within at least one rotor (10) circumferential length to be wound, preferably within at least two rotor (10) circumferential lengths to be wound and still more preferably within at least three rotor (10) circumferential lengths to be wound, between the maximum bias and zero or the initial/final value.

7. The method of claim 1,
wherein several winding layers (32a, 32b, 32c) of the wire-like structure (20) are wound on top of one another on the outer circumference (12) of the rotor (10); wherein the several winding layers (32a, 32b, 32c) arranged on top of one another are wound at an identical winding angle with respect to a plane orthogonal to the rotor axis (A).

8. The method of claim 1, wherein several winding layers (32a, 32b, 32c) of the wire-like structure (20) are wound on top of one another on the outer circumference (12) of the rotor (10);
wherein the several winding layers (32a, 32b, 32c) arranged on top of one another are wound at different winding angles with respect to a plane orthogonal to the rotor axis (A).

9. The method of claim 7,
wherein the several winding layers (32a, 32b, 32c) arranged on top of one another are wound from different wire-like structures (20).

10. The method of claim 1,
wherein a wire-like structure (20) having a diameter of at least 0.2 mm, preferably a diameter of at least 0.3 mm, and in particularly preferred manner a diameter of at least 0.5 mm, is wound onto the outer circumference of the rotor (10), and
wherein a wire-like structure (20) having a diameter of at most 3 mm, preferably a diameter of at most 2.5 mm, and in particularly preferred manner a diameter of at most 2 mm, is wound onto the outer circumference of the rotor (10).

11. The method of claim 1,
wherein the wire-like structure is wound onto an outer circumference (12) of the rotor (10) having a diameter of at least 30 mm, preferably at least 100 and in particularly preferred manner at least 300 mm, and
wherein the wire-like structure (20) is wound across an axial length of at least 25 mm on the outer circumference (12) of the rotor (10), preferably across an axial length between 25 mm and 1000 mm, and in particularly preferred manner across an axial length between 50 mm and 1000 mm.

12. The method of claim 1,
wherein the wire-like structure (20) is wound onto a plurality of rotor components (16) distributed around the outer circumference (12) of the rotor (10), with the outsides of the rotor components (16), in a cross-section orthogonal to the rotor axis (A), being arranged on a polygonal course, and with the wire-like structure being wound around the polygonal course.

13. The method of claim 1,
wherein the wire-like structure (20) is provided with an insulating varnish coating or an insulating spun sheathing, and
wherein a layer of insulating material is applied between individual layers (32a, 32b, 32c) of the wire-like structure (20) wound onto the circumference of the rotor.

14. A rotor (10) for an electric machine, comprising a rotor body (14) which is adapted to be rotated about a rotor axis (A) and has at least one rotor component (16) to be mounted on the rotor body (14), and a wire-wrap bandage (18) of a wire-like structure (20) that is wound around an outer circumference (12) of the rotor body (14) having the rotor component (16) disposed thereon so as to form a bandage (18), with the wire-like structure (20) being held under an adjustable bias and wherein the wire-like structure (20) is wound with a maximum bias that is above the yield strength and below the tensile strength of the wire like-structure (20).

15. The rotor of claim 14,
wherein the rotor component (16) is attached to an outer surface of the rotor body (14), and
wherein the rotor component (16), at least with regard to forces acting in circumferential direction, is attached in form-fit manner in recesses formed in the rotor body (14).

16. The rotor of claim 14,
wherein the wire-like structure (20) has an electric conductivity of at the most 10·10⁶ A/(V·m), preferably at the most 5·10⁶ A/(V·m), with at the most 3·10⁶ N(V·m) being particularly preferred.

17. The rotor of claim 1,
wherein the wire-like structure (20) is made of nonmagnetic material, particularly of titanium, a titanium alloy or a nonmagnetic stainless steel.

18. The rotor of claim 1,
wherein the wire-like structure (20) is made of a ferromagnetic material; particularly comprising successive first and second portions, the first portions having a first magnetic permeability and the second portions having a second permeability that is less than said first permeability.

19. The rotor (10) of claim 14,
comprising at least one of the properties indicated in claims 1 to 16.

20. An apparatus (100) for producing a rotor (10) for an electric machine, said rotor comprising:
a rotor body (14) adapted to rotate about a rotor axis (A);
at least one rotor component (16) to be mounted to the rotor body (14); and
a wire-wrap bandage (18) of a wire-like structure (20) that is wound around an outer circumference (12) of the rotor body (14) having the rotor component (16) disposed thereon, so as to form a bandage (18),
said apparatus comprising:
a wire guide means (26) for guiding the wire-like structure (20) onto the outer circumference (12) of the rotor (14) to be provided with a wire wrap, and
a support (28) for the rotor body (14) which permits the rotor body (14) to be set into rotation,
said apparatus (100) permitting adjustment of the bias of the wire-like structure (20) by cooperation of the wire guide means (26) and a rotational drive acting on the rotor body (14) such that the wire-like structure (20) is wound with a maximum bias that is above the yield strength and below the tensile strength of the wire like-structure (20).

21. The apparatus (100) of claim 20,
comprising a control (300) for actively controlling the bias of the wire-like structure (20) in the section (20a) thereof between the wire guide means (26) and the rotor body (14) by cooperation of the wire guide means (26) and the drive acting on the rotor body.
